(19) United States
(12) Patent Application Publication
(10) Pub. No.: US 2013/0277188 A1
(43) Pub. Date: Oct. 24, 2013

(54) BUTTON CAP WITH A RAISED CLEAR COVER

(71) Applicant: Patrick DiStefano, Camarillo, CA (US)

(72) Inventor: Patrick DiStefano, Camarillo, CA (US)

(21) Appl. No.: 13/454,899

(22) Filed: Apr. 24, 2012

(51) Int. Cl. H01H 13/83

(52) U.S. Cl. 200/314

(57) ABSTRACT

The invention generally relates to button caps used on electronic devices. It more particularly relates to button caps that enhance the user experience of devices such as smartphones, tablets and the like. In one aspect the invention is a raised button cap for a concave (or flat) button such as the Home Button on smartphones and tablets. The button cap includes adhesive backing for attachment to the button, a printable substrate and a clear magnifying dome covering the substrate, combined into a unit that when adhered to concave button provides a raised aspect. The button is preferably made from tough self-healing materials, and the flat substrate is suitable as a base for either printed images, preferably customizable, and/or small decorative objects such as jewels, small insects or the like.

### RELATED APPLICATIONS

N/A

### FEDERALLY SPONSORED RESEARCH

Not Applicable

### SEQUENCE LISTING

Not Applicable

### FIELD OF THE INVENTION

The invention generally relates to button caps used on electronic devices. It more particularly relates to button caps that enhance the user experience of devices such as smartphones, tablets and the like.

### BACKGROUND OF THE INVENTION

Modern personal computing appliances, such as smartphones and tablets, have typically adopted the user interface model of the Apple iPhone and iPad devices. The user interface is primarily a touch screen where the wide variety of functions and data available on the device are accessed by touches or swipes on a screen. A key part of this interface model is a mechanical switch commonly referred to as the “Home Button”. The Home Button acts as an entry point into the device. Home Button actuation awakens the device and displays its current state, including receipt of text messages and phone calls. All iPhone and iPad Home Buttons are of a concave (or flat) design, with the Native Phone Button designed as a depression (or flat spot) in the face of the device as shown in FIG. 1a. In particular, the home button depression on Apple devices has a beveled edge

Despite the various Home Button configurations for electronic devices, there is a need for new configurations and accessories that provide for new configurations.

One possible approach to both changing the tactile impression and decorative aspects of a concave button is provide a user installable button cover or cap, that may be both raised in physical aspect and have a different visual appearance to the standard button. Such button caps, designed for iPhone Home Buttons, are available. However to date, the decorative options and user personalization capability of the button caps are minimal, and their physical characteristics are inferior to the look and feel of the product for which the caps are intended. It is desirable to provide a button cap, primarily intended for Home Buttons on smartphones and tablets, which is an improvement visually, is highly personalizable, provides a raised convex aspect instead of concave, and is made of materials suitable for the harsh usage environment experienced by these devices.

### BRIEF SUMMARY OF THE INVENTION

In one aspect, the invention is a raised button cap for a concave (or flat) button such as the home button on smartphones, including a printable media substrate, sized to substantially fill the area of the button while maintaining actuation of the button, an adhesive, and a clear, magnifying dome over the media surface. The substrate, backing, and magnifying dome are formed together into a unitary object, attachable to the button with the adhesive, to form a raised actuatable button. For the case where the button cap is intended for iPhone or iPad application, the cap is sized to fit within the beveling around the edge of the native home button.

In some embodiments, the media substrate is vinyl and/or the clear magnifying dome is made from a mixture of Isocyanate and Polyol.

In preferred embodiments, the height of the cap from adhesive to the top of the dome is between 0.050 and 0.085 inches.

In another embodiment, the substrate and dome covering are substantially circular in outline. In a particular version, the diameter of the cap is less than 0.5 inches.

In various detailed embodiments, the media substrate is printed with an image and/or a decorative object is enclosed within the dome. At least one of the substrate or the cover may contain glow-in-the-dark material. In a particular embodiment the button cap may contain a light source, preferably an LED and a power supply, preferably including a solar cell. The light source is preferably controlled by a controller. In one version the button cap is applied to the home button on a personal device and the light source controller includes a wireless interface which may connect to a wireless interface on the personal device. In conjunction with an application running on the personal device, the light source is caused to flash in time with music playing on the device. The light source, power supply and controller can take several alternate configurations or combinations of configurations, including, conventional battery, possibly removable, motion activated, and direct activation.

### BRIEF DESCRIPTION OF THE DRAWINGS

The invention will be better understood by referring to the following figures.

FIG. 1 shows views of an exemplary device with and without the invention installed.

FIG. 2 shows several elements of the invention in cross-section.

FIG. 3 shows alternative versions of the invention.

FIG. 4 shows further alternative versions of the invention.

FIG. 5 shows the invention with an image on the substrate.

FIG. 6 shows the invention with a decorative object on the substrate.

FIG. 7 shows the device with an integrated light source, controller and wireless interface.

### DETAILED DESCRIPTION OF THE INVENTION

The invention generally relates to button caps used on electronic devices. It more particularly relates to button caps that enhance the user experience of devices such as smartphones, tablets and the like.

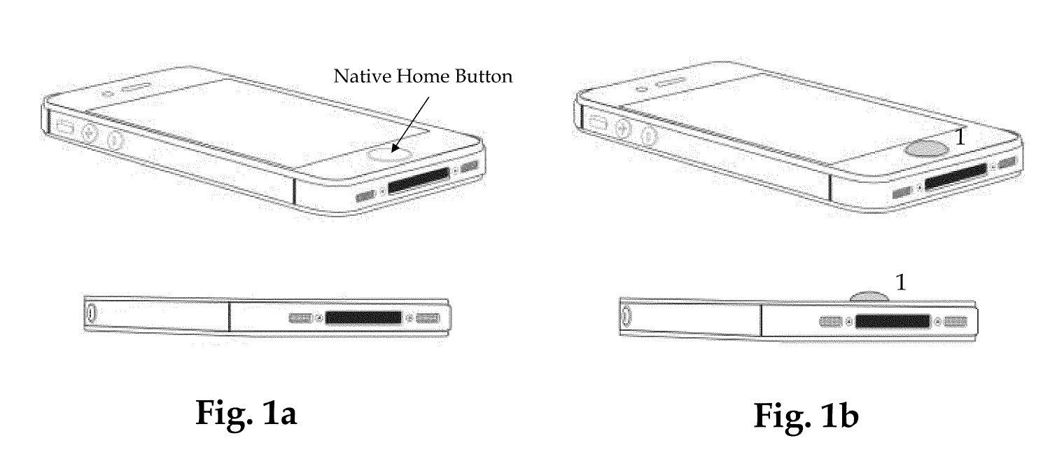

In one aspect, the invention is a raised domelike button cap that can be attached by a user to a concave or flat button, such as the Home Button on a smartphone or tablet. FIGS. 1a and 1b respectively show an exemplary device with and without the installed invention.

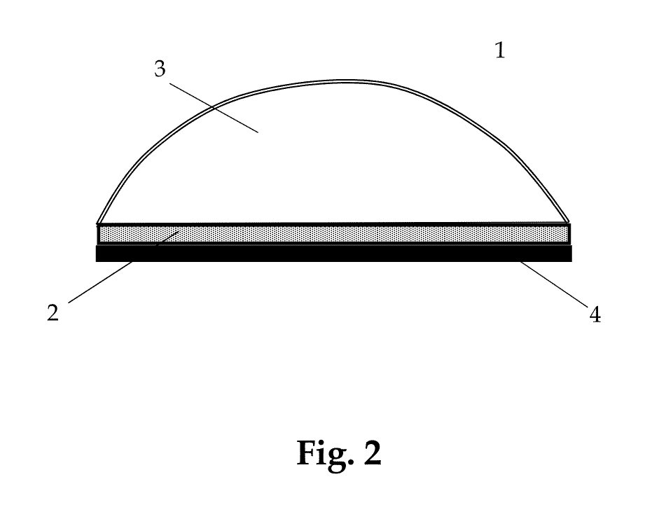

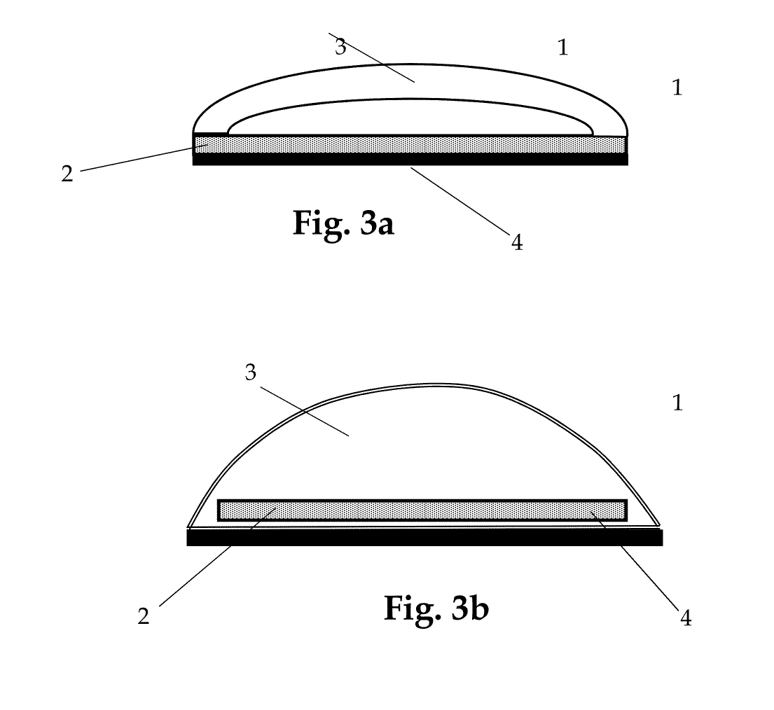

The button cap is structurally unique. Referring to FIG. 2, button cap 1 is an assembly containing at least three elements. First, a substrate 2, comprising a printable media forms the base of the cap. Preferably, an adhesive backing 4 is formed on the bottom of substrate 2. Suitable implementations of the adhesive backing are well known in the art. Formed onto the substrate is a clear raised dome cover 3, chosen for both suitable material properties and to provide magnification of the substrate. The three elements are formed together into a dome button cap sticker, which can be adhered to a flat or concave button, transforming the button into a raised button. The magnifying dome causes the substrate surface to be bright and clear, allowing for very small images or structures to be viewed with high clarity. The preferred cap is a shown in FIG. 2 with the dome material 3 completely filling the volume above the substrate 2. However, alternative implementations will suggest themselves to one skilled in the art. For instance, as shown in FIG. 3a dome 3 may enclose some open space as opposed to filling the volume completely. Alternatively, as shown in FIG. 3b, the substrate 2 may be potted within the dome material 3 and the adhesive 4 may be applied to the dome material 3. The cap is sized such that, when stickered to a button, it allows actuation of the button. In the case of the beveled home buttons on Apple devices, the cap is preferably sized to fit within the beveling.

Suitable materials for the printable media substrate include vinyl, which is strong and resilient even in thin sheet form and easily colored to suit a particular style or visual appearance.

In an embodiment, the chemical compositions forming the dome comprise Chem Dec 808 Isocyanate and Chem Dec 808 Polyol. The compositions are substantially and evenly mixed by a doming machine to create the dome compound. The material is clear, does not yellow, is tough and has self-healing properties; it exhibits both viscous and elastic characteristics. When pressure or penetrating forces are applied to the dome causing deformation or tensile stress, the material can quickly return to its original shape once the stress is removed.

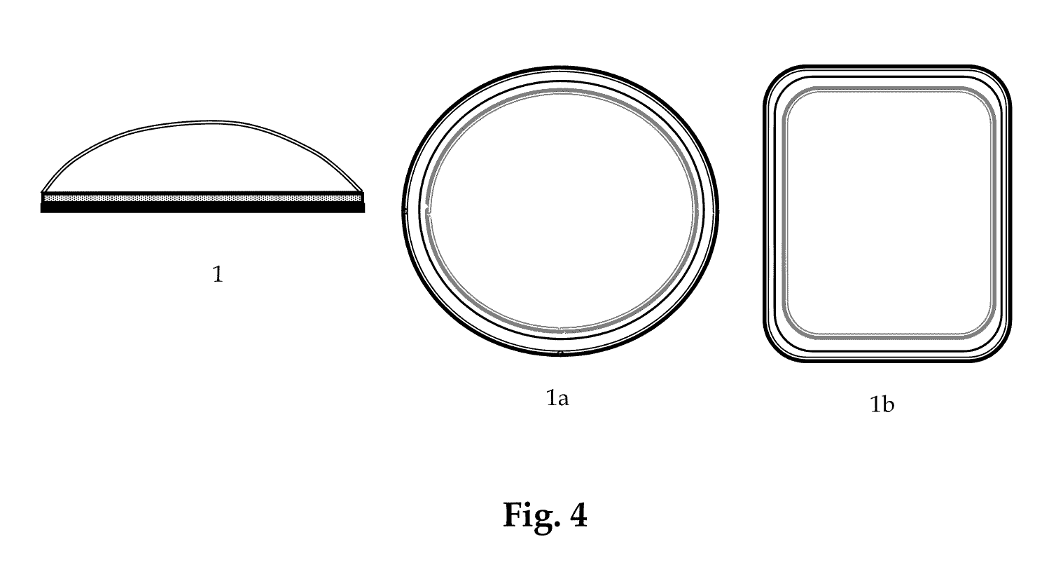

The button cap can be constructed and applied to fit a wide range of applications. For instance, the button caps may be round (1a) as shown in FIG. 4 and less than 0.5″ diameter (the iPhone Home Button is 0.47″ diameter for example). Nonlimiting examples of diameter ranges include: 0.25″ to 0.50″; 0.30″ to 0.50″; 0.35″ to 0.50″; 0.40″ to 0.50″; and, 0.45″ to 0.50″. The height range of the button cap—i.e., from the bottom of the substrate to the top of the dome—is typically from 0.05″ to 0.085″. Nonlimiting examples of height ranges include: 0.055″ to 0.085″; 0.060″ to 0.085″; 0.060″ to 0.080″; 0.060″ to 0.075″; 0.060″ to 0.070″; and, 0.060″ to 0.065″.

Although the iPhone Home Button is round, the button cap can be made with a clear domed covering in other shapes, such as rectangular (1b) as shown in FIG. 4. Other shapes, such as stars, polygons and the like are also possible, as well as a variety of sizes.

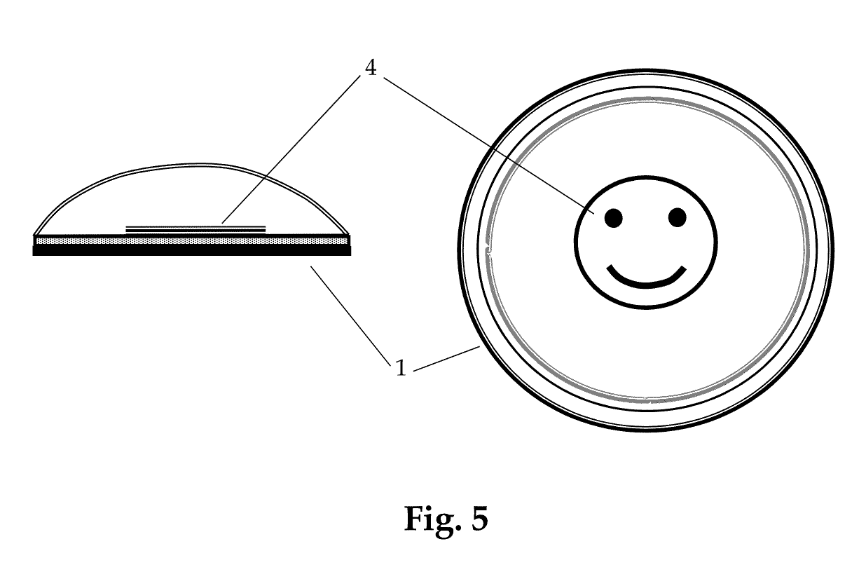

The button cap typically includes at least one decorative element. As shown in FIG. 5, an image 4 may be printed on the substrate. With a clear dome of the type described above, detailed images such as faces are clearly resolvable, even for a half-inch diameter button.

Button caps can be made with user specified images. An image can be uploaded using an online ordering process, and it can be applied to the caps. Manufacturing button caps with specified images can be performed in small numbers (10 or even less) without appreciably increasing the cost of manufacturing compared to caps with stock images.

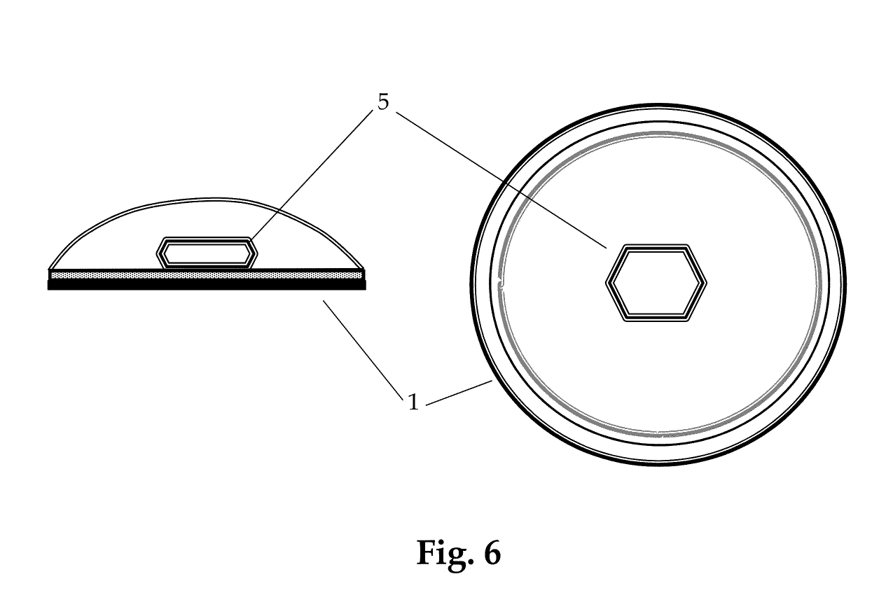

As shown in FIG. 6, alternatively or in conjunction with a printed image, a small object, (stone, insect, etc.) may be placed on the substrate and anchored in place by adhesive, the potting effect of the dome or some combination thereof. The button cap structure may be impregnated with a glow in the dark substance of a kind known in the art.

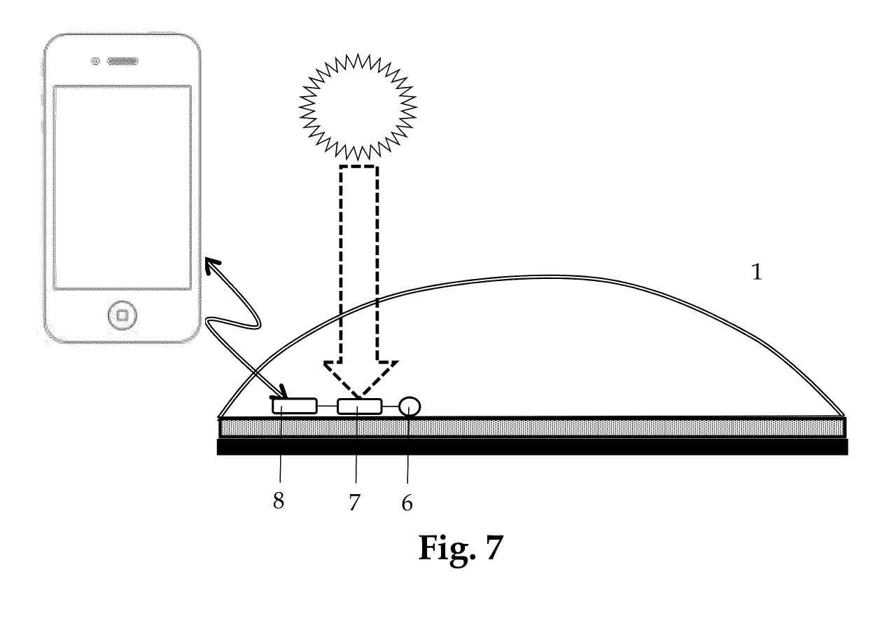

The button cap 1 as shown in FIG. 7 may also contain an integrated light source 6, preferably an LED, and power supply 7. Preferably the power supply 7 for light source 6 includes a solar cell. A controller 8 to actuate the light source 6 also preferably is included. Although the controller 8 operation may be simple such as pressure sensitive, an interesting version is possible. Controller 8 may include a wireless interface such as Bluetooth, compatible with the Bluetooth interface commonly found on the types of devices with home buttons. The wireless light source controller interface could connect with the device interface, and in conjunction with an application running on the device, cause the light source to flash in time with music played on the device. Variants such as multiple colored light sources with different colors flashing at different times would also be possible. The controller may also be motion activated or light sensitive, or some combination of external signal and direct activation. It is conceived that the lighted button could serve as an emergency light source such as to provide visibility for a user in dark conditions such as an unlit road at night.

The foregoing description of the embodiments of the present invention has shown, described and pointed out the fundamental novel features of the invention. It will be understood that various omissions, substitutions, and changes in the form of the detail of the systems and methods as illustrated as well as the uses thereof, may be made by those skilled in the art, without departing from the spirit of the invention. Consequently, the scope of the invention should not be limited to the foregoing discussions, but should be defined by appended claims.

I claim:

1. A raised button cap for a concave button such as the home button on devices such as smartphones and tablets, comprising:
a printable media substrate, sized to substantially fill the area of the concave button while maintaining actuation of the button,
an adhesive backing; and,
a clear, magnifying dome over the media surface; wherein the substrate, backing, and magnifying dome are formed together into a unitary object, attachable to the concave button with the adhesive, to form a raised actuatable button.

2. The button cap of claim 1 wherein the media substrate comprises vinyl.

3. The button cap of claim 1 wherein the clear magnifying dome comprises a mixture of Isocyanate and Polyol.

4. The button cap of claim 1 wherein the height of the cap from adhesive to the top of the dome is between 0.050 and 0.085 inches.

5. The button cap of claim 1 wherein the substrate and dome covering are substantially circular in outline.

6. The button cap of claim 5 wherein the diameter of the cap is less than 0.5 inches.

7. The button cap of claim 1 wherein the media substrate is printed with an image.

8. The button cap of claim 1 wherein a decorative object is enclosed within the dome.

9. The button cap of claim 1 wherein at least one of the substrate or the cover contains glow-in-the-dark material.

10. The button cap of claim 1 further comprising a light source and a power supply for the light source.

11. The button cap of claim 10 wherein the light source is an LED.

12. The button cap of claim 10 wherein the power supply comprises at least one of a solar cell, conventional battery or removable battery.

13. The button cap of claim 10 further comprising a controller for the light source.

14. The button cap of claim 13 wherein the controller comprises a wireless interface.

15. The button cap of claim 14 wherein the button cap is used as a home button cap on a computing device and the wireless interface is compatible with a wireless interface on the device.

16. The button cap of claim 15 wherein the button wireless interface connects to the device interface and in conjunction with an application running on the device causes the light source to flash in time with music playing on the device.

17. The button cap of claim 13 wherein the controller is at least one of motion activated, direct activated, or light sensitive.

18. The button cap of claim 1 wherein the button cap is used as a home button cap on a device with a beveled home button and the button cap is sized to fit within the beveling.
